(19) United States
(12) Patent Application Publication
(10) Pub. No.: US 2025/0353516 A1
(43) Pub. Date: Nov. 20, 2025

(54) DRIVING ASSISTANCE SYSTEM

(71) Applicant: TOYOTA JIDOSHA KABUSHIKI KAISHA, Toyota-shi (JP)

(72) Inventor: Kentaro MATSUMOTO, Yokohama-shi (JP)

(73) Assignee: TOYOTA JIDOSHA KABUSHIKI KAISHA, Toyota-shi (JP)

(21) Appl. No.: 19/183,156

(22) Filed: Apr. 18, 2025

(30) Foreign Application Priority Data
May 16, 2024 (JP) 2024-080462

(51) Int. Cl. B60W 50/14; B60W 30/18; B60W 40/08

(52) U.S. Cl. CPC B60W 50/14; B60W 30/18163; B60W 40/08; B60W 2040/0809; B60W 2040/0818; B60W 2050/143; B60W 2050/146; B60W 2540/043; B60W 2540/225; B60W 2540/229; B60W 2556/10

(57) ABSTRACT

A driving assistance system notifies a driver of a vehicle with a notification of an automatic lane change for automatically changing a lane of the vehicle before executing the automatic lane change, and executes the automatic lane change in a case where a preset standby time corresponding to the driver of the vehicle has elapsed after the notification is performed.

### TECHNICAL FIELD

The present disclosure relates to a driving assistance system.

### BACKGROUND

For example, Japanese Unexamined Patent Publication No. 2002-195063 discloses a technique of stopping assistance control of a vehicle in a case where a driving operation suitable for driving characteristics of a driver of a vehicle (hereinafter, also simply referred to as a “driver”) is not performed as a technique related to a driving assistance system.

### SUMMARY

Incidentally, a system that performs an automatic lane change for automatically changing a lane of the vehicle in a case where another vehicle with a low vehicle speed is present in front of a lane on which the vehicle travels to pass the other vehicle or performs an automatic lane change to travel to a destination has been known as the driving assistance system. In such a driving assistance system, the driver may be notified of the automatic lane change in advance. However, the vehicle starts lateral movement before the driver checks the surroundings depending on a start timing of the automatic lane change after the notification is performed, and a sense of security may be impaired.

Therefore, an object of an aspect of the present disclosure is to provide a driving assistance system capable of ensuring a sense of security of a driver of a vehicle.

(1) A driving assistance system according to an aspect of the present disclosure notifies a driver of a vehicle with a notification of an automatic lane change for automatically changing a lane of the vehicle before executing the automatic lane change, and executes the automatic lane change in a case where a preset standby time corresponding to the driver of the vehicle has elapsed after the notification is performed.

In this driving assistance system, the automatic lane change can be executed at a start timing suitable for a feeling of the driver of the vehicle, and the sense of security of the driver of the vehicle can be secured.

(2) In the driving assistance system according to the above (1), the preset standby time corresponding to the driver of the vehicle may be a time set based on a driving operation time history at the time of a lane change by manual driving of the driver of the vehicle. In this case, the automatic lane change can be executed at the start timing suitable for a driving operation at the time of a usual lane change of the driver.

(3) In the driving assistance system according to the above (2), the driving operation time history may be a history of a time from a pre-operation of the driver of the vehicle before starting a lane change at the time of manual driving to steering of an actual lane change. In this case, it is possible to specifically implement the above-described operations and effects that the automatic lane change can be executed at the start timing suitable for the driving operation at the time of the usual lane change of the driver.

(4) In the driving assistance system according to the above (2) or (3), the driving operation time history may be a history of a first time that is a time from a directional indicator operation by the driver of the vehicle at the time of the manual driving to the steering of the actual lane change. In this case, it is possible to more specifically implement the above-described operations and effects that the automatic lane change can be executed at the start timing suitable for the driving operation at the time of usual lane change of the driver.

(5) In the driving assistance system according to the above (2) or (3), the driving operation time history may be a history of a second time that is a time from movement of a line of sight or a face orientation to a door mirror side in a direction of the lane change by the driver of the vehicle to the steering of the actual lane change in a case where the driver of the vehicle operates a directional indicator within a certain time after moving the line of sight or the face orientation to the door mirror side at the time of the manual driving. In this case, it is possible to more specifically implement the above-described operations and effects that the automatic lane change can be executed at the start timing suitable for the driving operation at the time of usual lane change of the driver.

(6) In the driving assistance system according to the above (4), the standby time may be an average value of a plurality of the first times. In this case, the plurality of first times can be reflected in the standby time.

(7) In the driving assistance system according to the above (5), the standby time may be an average value of a plurality of the second times. In this case, the plurality of second times can be reflected in the standby time.

(8) In the driving assistance system described in any one of the above (1) to (7), in a case where the driver of the vehicle visually checks surroundings of the vehicle after the notification is performed, the standby time may be shortened as compared with a case where the driver does not visually check. In this case, whether or not the driver visually checks can be reflected in the start timing of the automatic lane change.

(9) In the driving assistance system described in any one of the above (1) to (8), the standby time in a case where the number of other vehicles present in surroundings of the vehicle is more than or equal to an upper limit threshold may be further lengthened than in a case where the number of other vehicles is less than the upper limit threshold, and the standby time in a case where the number of other vehicles is less than or equal to a lower limit threshold may be further shortened than in a case where the number of other vehicles is more than the lower limit threshold. In this case, the congestion situation in the surroundings of the vehicle can be reflected in the start timing of the automatic lane change.

(10) In the driving assistance system described in any one of the above (1) to (9), the vehicle may have a personal authentication function, the standby time at the end of a latest operation of each of a plurality of the drivers may be stored as a stored value, and in a case where the driver is personally authenticated by the personal authentication function at a start of driving, at which the driver starts driving the vehicle, the stored value associated with the driver may be set as an initial value of the standby time. In this case, the automatic lane change can be executed at the start timing more suitable for the feeling of the driver.

According to the aspect of the present disclosure, it is possible to provide the driving assistance system capable of securing the sense of security of the driver of the vehicle.

### BRIEF DESCRIPTION OF THE DRAWINGS

FIG. 1 is a block diagram showing a configuration of a driving assistance system according to an embodiment;

FIG. 2 is a diagram showing an example of notification displayed in an HMI of FIG. 1; and

FIG. 3 is a flowchart showing processing of the driving assistance system of FIG. 1.

### DETAILED DESCRIPTION

Hereinafter, embodiments will be described with reference to the accompanying drawings. In the following description, the same or corresponding elements are denoted by the same reference signs, and redundant description will be omitted.

### First Embodiment

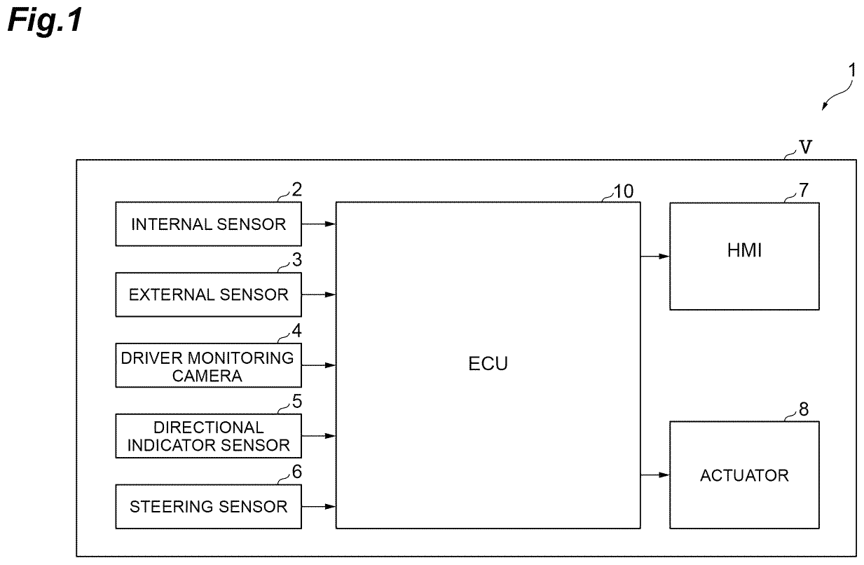

A first embodiment will be described. As shown in FIG. 1, a driving assistance system 1 according to the present embodiment is mounted on a vehicle V. The vehicle V may be a passenger vehicle or a cargo vehicle. One or more occupants can board the vehicle V. The vehicle V may be an autonomous driving vehicle capable of autonomous driving. The vehicle V can be manually driven by a driver.

The driving assistance system 1 is a system capable of executing an automatic lane change for automatically changing a lane of the vehicle V. The automatic lane change is, for example, control for automatically changing the lane of the vehicle V under a specific condition. As an example, in a case where there is another vehicle with a slow vehicle speed in front of a lane on which the vehicle V travels, the automatic lane change is executed to overtake the other vehicle. As another example, the automatic lane change is executed to travel to a destination. The destination is not particularly limited, and is, for example, an exit of a highway. The automatic lane change may be, for example, a function in autonomous driving or a function in driving assistance (advanced drive or the like). The driving assistance system 1 includes an electronic control unit (ECU) 10.

The ECU 10 is an electronic control unit including a central processing unit (CPU), a read only memory (ROM), and a random access memory (RAM). The ECU 10 implements various functions by, for example, loading a program stored in the ROM into the RAM and executing the program loaded in the RAM by the CPU. A part of the functions of the ECU 10 may be executed in a server that can communicate with the vehicle V. The ECU 10 may include a plurality of electronic units. An internal sensor 2, an external sensor 3, a driver monitoring camera 4, a directional indicator sensor 5, a steering sensor 6, an HMI 7, and an actuator 8 are connected to the ECU 10.

The internal sensor 2 is a detection device that detects a traveling state of the vehicle V. The internal sensor 2 includes a vehicle speed sensor, an acceleration sensor, and a yaw rate sensor. The vehicle speed sensor is a detector that detects a speed of the vehicle V. For example, a wheel speed sensor that detects a rotation speed of a wheel is used as the vehicle speed sensor. The vehicle speed sensor transmits detected vehicle speed information to the ECU 10. The acceleration sensor is a detector that detects an acceleration of the vehicle V. The acceleration sensor transmits, for example, acceleration information of the vehicle V to the ECU 10. The yaw rate sensor is a detector that detects a yaw rate (rotation angular velocity) around a vertical axis of a center of gravity of the vehicle V. For example, a gyro sensor can be used as the yaw rate sensor. The yaw rate sensor transmits the detected yaw rate information of the vehicle V to the ECU 10.

The external sensor 3 is a detection device that detects a surrounding environment of the vehicle V. The external sensor 3 includes a camera and a radar sensor. The camera is provided, for example, on a back side of a windshield of the vehicle V and images the front of the vehicle V. The camera may be provided on a back surface and a side surface of the vehicle V. The camera transmits imaging information in the surroundings of the vehicle V to the ECU 10. The camera may be a monocular camera or a stereo camera. The radar sensor is a detection device that detects an obstacle in the surroundings of the vehicle V by using radio waves (for example, millimeter waves) or light. The radar sensor includes, for example, a millimeter wave radar or a lidar. The radar sensor transmits the detected obstacle information to the ECU 10.

The driver monitoring camera 4 is a camera that monitors the driver. The driver monitoring camera 4 images, for example, a head part of the driver. The head part used herein is a portion above the neck and includes the entire face. A plurality of driver monitoring cameras 4 may be provided to image the driver from a plurality of directions. The driver monitoring camera 4 transmits, to the ECU 10, a driver image obtained by imaging the driver. The directional indicator sensor 5 detects an operation of a directional indicator (direction indicator lamp) of the driver. The directional indicator sensor 5 transmits detected directional indicator operation information to the ECU 10. The steering sensor 6 detects an operation of a steering unit (steering) by the driver. The steering sensor 6 transmits detected object information to the ECU 10.

The HMI 7 is an interface for inputting and outputting information to and from the driver. The HMI 7 includes, for example, a display (display unit) and a speaker that can be visually recognized by the driver. The HMI 7 outputs an image from the display and outputs a voice from the speaker in response to a control signal from the ECU 10. The HMI 7 may include a head up display (HUD). The HMI 7 may be able to receive a driver operation related to the operation and stop of the automatic lane change.

The actuator 8 is a device used for controlling the vehicle V. The actuator 8 includes at least a drive actuator, a brake actuator, and a steering actuator. The drive actuator controls an engine and/or a motor as a power source in response to a control signal from the ECU 10 to control a driving force of the vehicle V. The brake actuator controls a brake system in response to a control signal from the ECU 10 to control a braking force to be applied to wheels of the vehicle V. The steering actuator controls driving of an assist motor that controls a steering torque in an electric power steering system in response to a control signal from the ECU 10. Accordingly, the steering actuator controls a steering torque of the vehicle V.

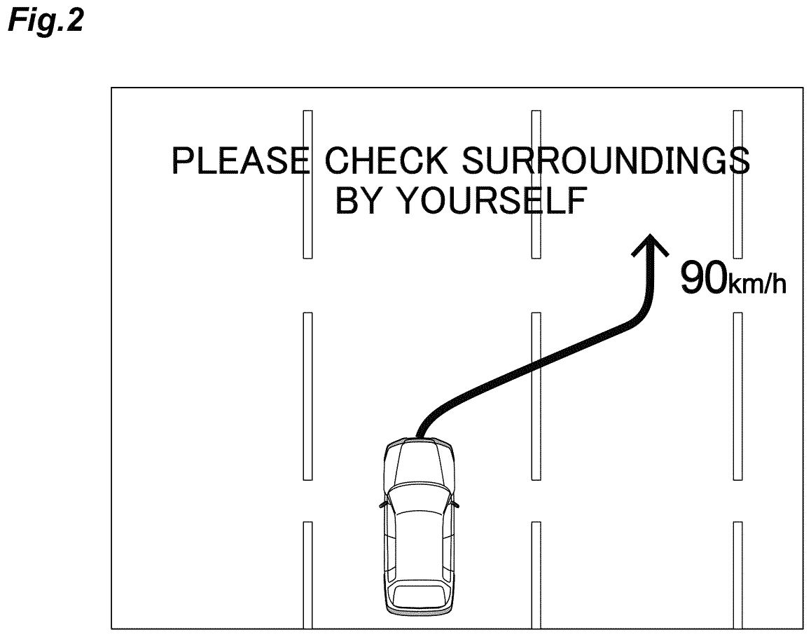

The driving assistance system 1 according to the present embodiment notifies the driver about the automatic lane change before executing the automatic lane change. As an example, the ECU 10 transmits a control signal to the HMI 7 before executing the automatic lane change, and displays, as the notification, a diagram illustrating a vehicle operation related to the lane change, the vehicle speed, and characters prompting check of the surroundings on the display of the HMI 7 (see FIG. 2). The ECU 10 may output a voice related to the automatic lane change from the speaker of the HMI 7.

In a case where a preset standby time corresponding to the driver of the vehicle V has elapsed after the notification regarding the automatic lane change is performed, the ECU 10 transmits a control signal to the actuator 8 and executes the automatic lane change. For example, the execution of the automatic lane change can be implemented by, in the ECU 10, generating a lane change trajectory from a traveling lane of the vehicle V to an adjacent lane based on detection results of the internal sensor 2 and the external sensor 3 and controlling the actuator 8 to travel along the lane change trajectory. “Driver of the vehicle V” related to the standby time includes not only a person who drives the vehicle V but also a person who has driven the vehicle V in the past. In the present embodiment, “driver of the vehicle V” related to the standby time is not limited to one specific person, and for example, in a case where the vehicle V is shared and used by a plurality of persons, each of the plurality of persons is “driver of the vehicle V”.

In the present embodiment, the preset standby time corresponding to the driver of the vehicle V is a time set based on a driving operation time history at the time of lane change by manual driving of the driver of the vehicle V. That is, in the present embodiment, “standby time corresponding to the driver of the vehicle V” is a standby time stored in the vehicle V and set in accordance with the driving operation time history updated by the current driving of the driver of the vehicle V. “Standby time corresponding to the driver of the vehicle V” is not limited to correspond to only a specific driver.

The driving operation time history is a history of a time from a pre-operation which is a driving operation of the driver of the vehicle V before starting the lane change at the time of manual driving (hereinafter, also simply referred to as “pre-operation”), to steering of an actual lane change. “From the pre-operation” means “from any point in time between a start point in time and an end point in time of the pre-operation”, may be, for example, from the start point in time of the pre-operation, may be from the end point in time of the pre-operation, or may be from an intermediate point in time between the start point in time and the end point in time of the pre-operation. “To actual steering of the lane change” means “to any point in time between a start point in time and an end point in time of the steering of the actual lane change”, may be, for example, to the start point in time of the steering of the actual lane change, may be to the end point in time of the steering of the actual lane change, or may be to an intermediate point in time between the start point in time and the end point in time of the steering of the actual lane change.

The pre-operation includes, for example, a directional indicator operation by the driver of the vehicle V before the steering of the actual lane change, movement of a line of sight of the driver of the vehicle V to a door mirror side in a direction of the lane change, and movement of a face orientation of the driver of the vehicle V to the door mirror side in the direction of the lane change. The directional indicator operation can be recognized by a known method based on the directional indicator operation information detected by the directional indicator sensor 5. A start point in time of the directional indicator operation can be, for example, a point in time when the directional indicator sensor 5 detects an operation of a directional indicator lever by the driver. An end point in time of the directional indicator operation may be a point in time identical to the start point in time of the directional indicator operation, or may be a point in time when a certain time elapses from the start point in time of the directional indicator operation. The door mirror in the direction of the lane change is a right door mirror in the case of a lane change to an adjacent lane on a right side of the vehicle V, and is a left door mirror in the case of a lane change to an adjacent lane on a left side of the vehicle V.

The movement of the line of sight of the driver of the vehicle V to the door mirror side can be recognized by a known method based on the driver image imaged by the driver monitoring camera 4. For example, in a case where the movement of the line of sight of the driver to the door mirror side is recognized, the eyes of the driver are detected from the driver image, and positions of pupils of the detected eye are specified. The line of sight of the driver is estimated from shapes of the detected eyes and the specified positions of the pupils. In a case where it is determined from a positional relationship between the driver and the door mirror that the estimated line of sight is positioned on the door mirror or a side of the door mirror, it is recognized that the line of sight of the driver moves to the door mirror side. A start point in time of the movement of the line of sight of the driver can be, for example, a point in time when the line of sight of the driver facing a front direction of the vehicle V moves to the door mirror side by a certain angle or more. An angle of the movement of the line of sight in this case can be calculated as, for example, a rotation angle in a horizontal direction around the head part of the driver. An end point in time of the movement of the line of sight of the driver is, for example, a point in time when the line of sight of the driver reaches the door mirror.

The movement of the face orientation of the driver of the vehicle V to the door mirror side can be recognized by a known method based on the driver image imaged by the driver monitoring camera 4. For example, in a case where the movement of the face orientation of the driver to the door mirror side is recognized, the face of the driver is detected from the driver image, and position information of feature points (for example, eyes, nose, and mouth) of the detected face is specified. The face orientation of the driver is estimated from a position and a size of the detected face and the position information of the specified feature points. In a case where it is determined from the positional relationship between the driver and the door mirror that the estimated face orientation is positioned on the door mirror or the side beyond the door mirror, it is recognized that the face orientation of the driver moves to the door mirror side. A start point in time of the face orientation of the driver can be, for example, a point in time when the face orientation of the driver facing the front direction of the vehicle V moves to the door mirror side by a certain angle or more. An end point in time of the face orientation of the driver can be, for example, a point in time when the face of the driver faces the door mirror.

The steering of the actual lane change can be recognized by a known method based on the steering information detected by the steering sensor 6 and a change in a traveling lane on which the vehicle V travels. The steering of the actual lane change corresponds to steering when the traveling lane of the vehicle V actually changes (for example, steering when the vehicle V moves to the adjacent lane across a white line of the traveling lane on which the vehicle V is traveling) among past steering detected by the steering sensor 6. Steering when the traveling lane of the vehicle V does not change during curve traveling or the like is not included in the steering of the actual lane change. For example, in a case where it is determined from traveling lane information that the traveling lane of the vehicle V changes, the steering performed in accordance with the change in the traveling lane may be recognized as the steering of the actual lane change. As an example, in a case where it is determined that the vehicle V changes the lane to the right adjacent lane, a point in time when the vehicle V starts turning a steering wheel to a right side at the time of the lane change may be set as the start point in time of the steering of the actual lane change, and a point in time when the vehicle V returns the steering wheel turned to the right side to an original position or a center position may be set as the end point in time of the steering of the actual lane change. The change in the traveling lane on which the vehicle V travels may be recognized by various known methods, and may be recognized, for example, by grasping whether or not the vehicle V crosses a white line from a detection result of a white line recognition camera.

The driving operation time history of the present embodiment is a history of a first time which is a time from the directional indicator operation by the driver at the time of manual driving to the steering of the actual lane change. The driving operation time history is stored in the ECU 10. The driving operation time history is updated, for example, by performing the lane change by the manual driving of the driver. “From the directional indicator operation” means “from any point of time between the start point in time and the end point in time of the directional indicator operation”, may be, for example, from the start point in time of the directional indicator operation, may be from the end point in time of the directional indicator operation, or may be from an intermediate point of time between the start point in time and the end point in time of the directional indicator operation.

The ECU 10 calculates an average value of a plurality of first times, and sets, as the standby time, the average value of the first times. The ECU 10 sets the standby time whenever the driving operation time history is updated. The ECU 10 may set the standby time at certain time intervals. In a case where the driving operation time history is not stored in the ECU 10, a predetermined standard value may be set as an initial value of the standby time. The average value is, for example, a value obtained by performing average processing such as arithmetic average, load average, and geometric average. The average processing is not particularly limited, and various kinds of average processing may be adopted. The ECU 10 may set, as the standby time, a median value or a mode value of the first times instead of the average value of the first times. The mode value is, for example, a time length having a highest appearance frequency when lengths of the plurality of first times are classified for each predetermined time. The predetermined time is not particularly limited. The predetermined time may be 0.5 seconds or 1 second.

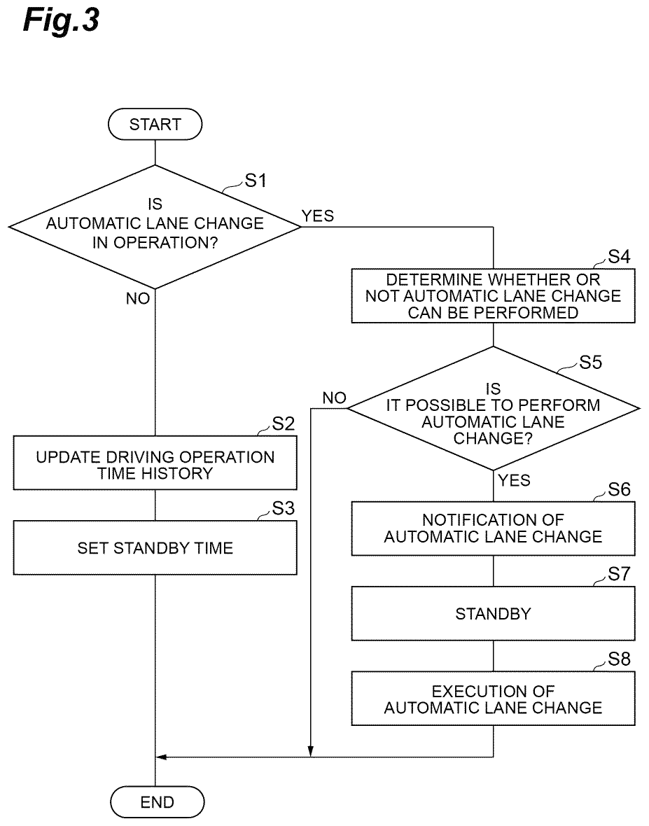

Next, processing of the driving assistance system 1 will be described with reference to a flowchart of FIG. 3.

For example, in a scene where the traveling vehicle V changes a lane, the ECU 10 determines whether or not the automatic lane change is in operation (step S1). In the case of NO in step S1, the lane change is executed by the manual driving of the driver. At that time, the first time which is the time from the directional indicator operation by the driver to the start of the actual steering is stored and updated as the driving operation time history in the ECU 10 (step S2). The ECU 10 averages the stored first times and sets, as the standby time, the average value of the first times (step S3). Thereafter, the processing ends.

In the case of YES in step S1, the ECU 10 determines whether or not the automatic lane change can be performed based on the detection result of the external sensor 3 (step S4). In a case where it is determined in step S4 that the automatic lane change cannot be performed (NO in step S5), the processing ends as it is without executing the automatic lane change.

On the other hand, in a case where it is determined that the automatic lane change can be performed (YES in step S5), the ECU 10 outputs the notification regarding the automatic lane change via the HMI 7 (step S6). After outputting the notification regarding the automatic lane change, the vehicle is on standby for the set standby time (step S7). Then, the ECU 10 executes the automatic lane change (step S8). Thereafter, the processing ends.

As described above, in the driving assistance system 1, the notification regarding the automatic lane change is performed before executing the automatic lane change. In a case where the preset standby time corresponding to the driver of the vehicle V elapses after the notification is performed, the automatic lane change is executed. Accordingly, the automatic lane change can be executed at a start timing suitable for the feeling of the driver of the vehicle V. It is possible to secure a sense of security of the driver of the vehicle V.

In the driving assistance system 1, the preset standby time corresponding to the driver of the vehicle V is a time set based on the driving operation time history at the time of the lane change by the manual driving of the driver of the vehicle V. In this case, the automatic lane change can be executed at a start timing suitable for the driving operation of the driver of the vehicle V at the time of a usual lane change.

In the driving assistance system 1, the driving operation time history is a history of the time from the pre-operation of the driver of the vehicle V before starting the lane change at the time of manual driving to the steering of the actual lane change. In this case, it is possible to specifically implement the above-described operations and effects that the automatic lane change can be executed at the start timing suitable for the driving operation at the time of the usual lane change of the driver.

In the driving assistance system 1, the driving operation time history is the history of the first time which is the time from the directional indicator operation by the driver of the vehicle V at the time of manual driving to the steering of the actual lane change. In this case, it is possible to more specifically implement the above-described operations and effects that the automatic lane change can be executed at the start timing suitable for the driving operation at the time of usual lane change of the driver.

In the driving assistance system 1, the standby time is the average value of the plurality of first times. In this case, the plurality of first times can be reflected in the standby time.

### Second Embodiment

A second embodiment will be described. In the description of the second embodiment, points different from the first embodiment will be described, and redundant description will be appropriately omitted.

A driving assistance system according to the present embodiment is different from the first embodiment in that the preset standby time corresponding to the driver of the vehicle V is a time that can be set by the driver himself or herself who drives the vehicle V via the HMI 7.

In the present embodiment, for example, before the driver starts driving the vehicle V, the ECU 10 displays an input screen of the standby time on the display of the HMI 7 and requests the driver to input the standby time. The input of the standby time may be a direct input of a value or a selection from a plurality of values different from each other. At this time, the driving operation time history, the average value of the first times, the intermediate value of the first times, and the like may be displayed on the display of the HMI 7 to support the input of the standby time by the driver. In a case where the value as the standby time is input via the HMI 7, the ECU 10 sets the value as the standby time. In a case where the value as the standby time is not input via the HMI 7, the ECU 10 sets the initial value as the standby time.

As described above, in the present embodiment, the automatic lane change can also be executed at the start timing suitable for the feeling of the driver of the vehicle V. It is possible to secure a sense of security of the driver of the vehicle V.

### Third Embodiment

A third embodiment will be described. In the description of the third embodiment, points different from the first embodiment will be described, and redundant description will be appropriately omitted.

A driving assistance system according to the present embodiment is different from the first embodiment in that the driving operation time history is a history of a second time. The second time is a time from the movement of the line of sight or the face orientation to the door mirror side by the driver of the vehicle V to the steering of the actual lane change in a case where the driver of the vehicle V operates the directional indicator within a certain time after moving the line of sight or the face orientation to the door mirror side in the direction of the lane change at the time of manual driving.

“After moving the line of sight or the face orientation” means “from any point in time between a start point in time and an end point in time of the movement of the line of sight or the face orientation”, may be, for example, from the start point in time of the movement of the line of sight or the face orientation, from the end point in time of the movement of the line of sight or the face orientation, or from an intermediate point between the start point in time and the end point in time of the movement of the line of sight or the face orientation. The certain time is not particularly limited, and may be various times. The certain time may be a fixed value or a variable value variable via the HMI 7.

The ECU 10 calculates an average value of the second times, and sets, as the standby time, the average value of the second time. The ECU 10 may set, as the standby time, a median value or a mode value of the second times instead of the average value of the second times.

As described above, in the present embodiment, the automatic lane change can also be executed at the start timing suitable for the feeling of the driver of the vehicle V. It is possible to secure a sense of security of the driver of the vehicle V.

In the present embodiment, the driving operation time history is a history of the second time. In this case, it is possible to more specifically implement the above-described operations and effects that the automatic lane change can be executed at the start timing suitable for the driving operation at the time of usual lane change of the driver. In the present embodiment, the standby time is the average value of the plurality of second times. In this case, the plurality of second times can be reflected in the standby time.

### Modification

Although the embodiments have been described above, one aspect of the present disclosure is not limited to the above-described embodiments. The aspect of the present disclosure can be performed in various forms with various modifications and improvements based on knowledge of those skilled in the art, including the above-described embodiments.

In the above-described embodiments, in a case where the driver visually checks the surroundings of the vehicle V after the notification is performed, the ECU 10 may shorten the standby time as compared with a case where the driver does not visually check. Whether or not the driver visually checks the surroundings of the vehicle V can be recognized by a known method based on the driver image imaged by the driver monitoring camera 4. For example, in a case where whether or not the driver visually checks the surroundings of the vehicle V is recognized, the face of the driver who drives the vehicle V is detected based on the driver image, and features such as the positions of the eyes, the sizes of the pupils, the opening and closing of eyelids, and the face orientation are extracted. Whether or not the driver visually checks the surroundings of the vehicle V is recognized based on the extracted features. The ECU 10 recognizes that the driver visually checks, for example, when the face orientation or the line of sight of the driver moves leftward or rightward by a certain angle or more with respect to the front of the vehicle. The certain angle is not particularly limited. For example, the certain angle may be 60° or 80°. The amount by which the standby time is shortened is not particularly limited, and may be a fixed value or a variable value variable via the HMI 7. In this case, whether or not the driver visually checks can be reflected in the start timing of the automatic lane change.

In the above-described embodiments, in a case where the number of other vehicles present in the surroundings of the vehicle V is equal to or more than an upper limit threshold, the ECU 10 may determine that a congestion situation in the surroundings of the vehicle V is dense (mixed), and may further lengthen the standby time than in a case where the number of other vehicles is less than the upper limit threshold. In a case where the number of other vehicles present in the surroundings of the vehicle V is less than or equal to a lower limit threshold, the ECU 10 may determine that the congestion situation in the surroundings of the vehicle V is empty (not mixed), and may shorten the standby time as compared with a case where the number of other vehicles is more than the lower limit threshold. The upper limit threshold and the lower limit threshold are, for example, values determined for determining the congestion situation in the surroundings of the vehicle V, and are not particularly limited, and may be various values. The upper limit threshold and the lower limit threshold may be fixed values or variable values variable via the HMI 7. The amount by which the standby time is lengthened and the amount by which the standby time is shortened are not particularly limited, and may be fixed values or variable values that are variable via the HMI 7. For example, the other vehicles present in the surroundings of the vehicle V may be other vehicle within a certain distance from the vehicle V in an adjacent lane of a lane change destination. The upper limit threshold and the lower limit threshold may be set in advance in the ECU 10 based on factors such as a speed of the vehicle V, a traffic condition, a type of a road, and a time zone. In this case, the congestion situation in the surroundings of the vehicle V can be reflected in the start timing of the automatic lane change.

In the above-described embodiments, the vehicle V may have a personal authentication function. The ECU 10 may store, as a stored value, a standby time at the end of latest driving of each of a plurality of drivers. The ECU 10 may set, as the initial value of the standby time, the stored value associated with the driver in a case where the driver is personally authenticated by the personal authentication function at a start of driving, at which the driver starts driving the vehicle V. Accordingly, for example, in a case where the plurality of people shares the vehicle V, it is possible to set the initial value of the standby time for each driver. It is possible to execute the automatic lane change at a start timing more suitable for the feeling of the driver of the vehicle V.

The personal authentication function is implemented by authentication means including, for example, biometric authentication means, PIN code input means, smart key authentication means, and a combination thereof when the driver accesses the vehicle V. As an example, fingerprint authentication means, face authentication means, iris authentication means, voiceprint authentication means, and the like can be considered as the biometric authentication means. When the driver gets on the vehicle V, these biometric authentication means identify the driver by automatically detecting biometric information of the driver by a sensor installed around the driver's seat and collating the biometric information with biometric information of the driver registered in advance. The PIN code input means specifies the driver by inputting a preset PIN code, for example, before the driver presses a start button of the vehicle V. The smart key authentication means specifies the driver by detecting that the smart key carried by the driver is near the vehicle V.

In the above-described embodiments, the standby time may be acquired by using a trained machine learning model. For example, at least a parameter regarding the driving operation time history at the time of the lane change by the manual driving of the driver of the vehicle V is input as an input parameter, and thus, the machine learning model may be a model that outputs output data regarding the standby time.

In the above-described embodiments, although the notification by display and/or voice via the HMI 7 is adopted as the notification regarding the automatic lane change, the present disclosure is not limited thereto, and various notifications may be adopted. For example, the notification by seat vibration may be adopted as the notification regarding the automatic lane change.

In the above-described embodiments, the standby time may be automatically adjusted in accordance with a notification mode. For example, in the case of a notification of only an image, there is a possibility that a time required for understanding the intention of the automatic lane change becomes longer than the voice notification. In a case where the driver relies only on visual information, the driver often needs to look away from a road to see the information, and thus, an additional recognition time is required. On the other hand, the voice notification enables the driver to receive information without moving his or her line of sight away from the road, and enables quick recognition. Accordingly, in the case of notification only by voice, the standby time may be set to be shorter than in the case of notification of only by the image.

In the above-described embodiments, “standby time corresponding to the driver of the vehicle V” may be a time corresponding to attributes (age, gender, and the like) of the driver who drives the vehicle V. As an example, the standby time is stored in the ECU 10 in association with the attributes. For example, in a case where the age is higher than a certain value, a larger standby time is stored as compared with a case where the age is less than the certain value. For example, in a case where the gender is female, a larger standby time than in a case where the gender is male is stored. Then, at the start of driving at which the driver starts driving the vehicle V, the attributes of the driver are specified by the personal authentication function, and the standby time stored in association with the specified attributes of the driver may be set as the standby time in the ECU 10.

In the above-described embodiments, “standby time corresponding to the driver of the vehicle V” may be a time corresponding to an individual driver who drives the vehicle V. As an example, the standby time is stored in the ECU 10 in association with an individual of the plurality of drivers. For example, the standby time is stored for each of a case where the driver is Mr. A, a case where the driver is Mr. B, and a case where the driver is Mr. C. At the start of driving at which the driver starts driving the vehicle V, the driver is authenticated by the personal authentication function, and the standby time stored in association with the authenticated driver may be set as the standby time in the ECU 10. The driving assistance system may set the standby time in advance in accordance with the driver of the vehicle V, and it is not essential to use the driving operation time history for setting the standby time.

What is claimed is:

1. A driving assistance system configured to notify a driver of a vehicle with a notification of an automatic lane change for automatically changing a lane of the vehicle before executing the automatic lane change, and to execute the automatic lane change in a case where a preset standby time corresponding to the driver of the vehicle has elapsed after the notification is performed.

2. The driving assistance system according to claim 1, wherein the preset standby time corresponding to the driver of the vehicle is a time set based on a driving operation time history at the time of a lane change by manual driving of the driver of the vehicle.

3. The driving assistance system according to claim 2, wherein the driving operation time history is a history of a time from a pre-operation of the driver of the vehicle before starting a lane change at the time of manual driving to steering of an actual lane change.

4. The driving assistance system according to claim 3, wherein the driving operation time history is a history of a first time that is a time from a directional indicator operation by the driver of the vehicle at the time of the manual driving to the steering of the actual lane change.

5. The driving assistance system according to claim 3, wherein the driving operation time history is a history of a second time that is a time from movement of a line of sight or a face orientation to a door mirror side in a direction of the lane change by the driver of the vehicle to the steering of the actual lane change in a case where the driver of the vehicle operates a directional indicator within a certain time after moving the line of sight or the face orientation to the door mirror side at the time of the manual driving.

6. The driving assistance system according to claim 4, wherein the standby time is an average value of a plurality of the first times.

7. The driving assistance system according to claim 5, wherein the standby time is an average value of a plurality of the second times.

8. The driving assistance system according to claim 1, wherein, in a case where the driver of the vehicle visually checks surroundings of the vehicle after the notification is performed, the standby time is shortened as compared with a case where the driver visually does not check.

9. The driving assistance system according to claim 1,
wherein the standby time in a case where the number of other vehicles present in surroundings of the vehicle is more than or equal to an upper limit threshold is further lengthened than in a case where the number of other vehicles is less than the upper limit threshold, and
the standby time in a case where the number of other vehicles is less than or equal to a lower limit threshold is further shortened than in a case where the number of other vehicles is more than the lower limit threshold.

10. The driving assistance system according to claim 1,
wherein the vehicle has a personal authentication function,
the standby time at the end of a latest operation of each of a plurality of the drivers is stored as a stored value, and
in a case where the driver is personally authenticated by the personal authentication function at a start of driving, at which the driver starts driving the vehicle, the stored value associated with the driver is set as an initial value of the standby time.
